(19) United States
(12) Patent Application Publication
(10) Pub. No.: US 2007/0074658 A1
(43) Pub. Date: Apr. 5, 2007

(54) Paint shield

(76) Inventor: Wendy Q. Creswell, Clear Spring, MD (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/239,492

(22) Filed: Sep. 30, 2005

(51) Int. Cl. B05C 11/11

(52) U.S. Cl. 118/504

(57) ABSTRACT

A paint shield including an elongated strip of corrugated cardboard having a top edge and a bottom edge connected by a pair of opposed ends. An impermeable plastic coating encapsulates the strip of corrugated cardboard. The plastic coating has a primary layer positioned upon the cardboard strip and adhesively fastened to it. A secondary layer encircles the strip of corrugated cardboard, from one of the opposed ends of the strip of corrugated cardboard to the other and between the top and bottom edges of the strip of corrugated cardboard. The top and bottom of the secondary layer define ruled margins running the length of the strip of corrugated cardboard for gauging overspray amounts.

### FIELD OF THE INVENTION

The present invention relates generally to coating apparatus and, more particularly, to work surface shields, masks, and protectors.

### BACKGROUND OF THE INVENTION

Professionals and do-it-yourself house painters often place paint on surfaces where it is not desired. The amount of paint that is misplaced is largely a matter of the care of the painter and the type of the tools that he uses. Certain tools, like rollers and brushes, generally put paint where it is wanted and require only thin strips of masking tape to segregate painted from unpainted areas. Spray guns, however, are used on larger projects and can produce considerable overspray, requiring that walls, floors, and trim surfaces be safeguarded to a greater degree. So, prior to spraying, it is common to place protective coverings such as newspapers and plastic tarps where paint is to be excluded. Unfortunately, newspaper shields and tarps are time-consuming to install and, because of their inherent flexibility, can move from their original positions during use, permitting paint to reach areas where it is not desired if a painter is not careful.

### SUMMARY OF THE INVENTION

In light of the problems associated with the known products for protecting walls, floors and trim surfaces from splattered paint and overspray, it is a principal object of the invention to provide a paint shield which is substantially rigid and portable permitting such to be easily pushed snugly against a wall, window frame, or other piece of trim to exclude paint therefrom.

Still another object of the invention is to provide a paint shield that can be folded and unfolded along a predetermined fold line for positioning flush against the corner of a window frame or doorframe. Folding also permits the paint shield to be conveniently stored in a toolbox.

It is a further object of the invention to provide a paint shield that does not absorb paint so that it can be washed for reuse.

It is another object of the invention to provide a paint shield of the type described with means for permitting a painter to judge the amount of overspray produced by his spray gun.

It is an additional object of the invention to provide a paint shield that it easy to use requiring neither additional tools nor prolonged training to put into practice.

It is an object of the invention to provide improved elements and arrangements thereof in a paint shield for the purposes described that is lightweight in construction, inexpensive to manufacture, and dependable in use.

Briefly, the paint shield in accordance with this invention achieves the intended objects by featuring an elongated strip of corrugated cardboard. An impermeable plastic coating encapsulates the strip of corrugated cardboard. The plastic coating is provided with ruled margins running its length for gauging overspray amounts.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a front view of a paint shield in accordance with the present invention.

FIG. 2 is an enlarged cross-sectional view of the paint shield along line 2-2 of FIG. 1.

FIG. 3 is a perspective view of the paint shield in a folded state being employed in the painting of one corner of a window frame.

FIG. 4 is a perspective view of the paint shield in an unfolded state being employed in the painting of a baseboard molding.

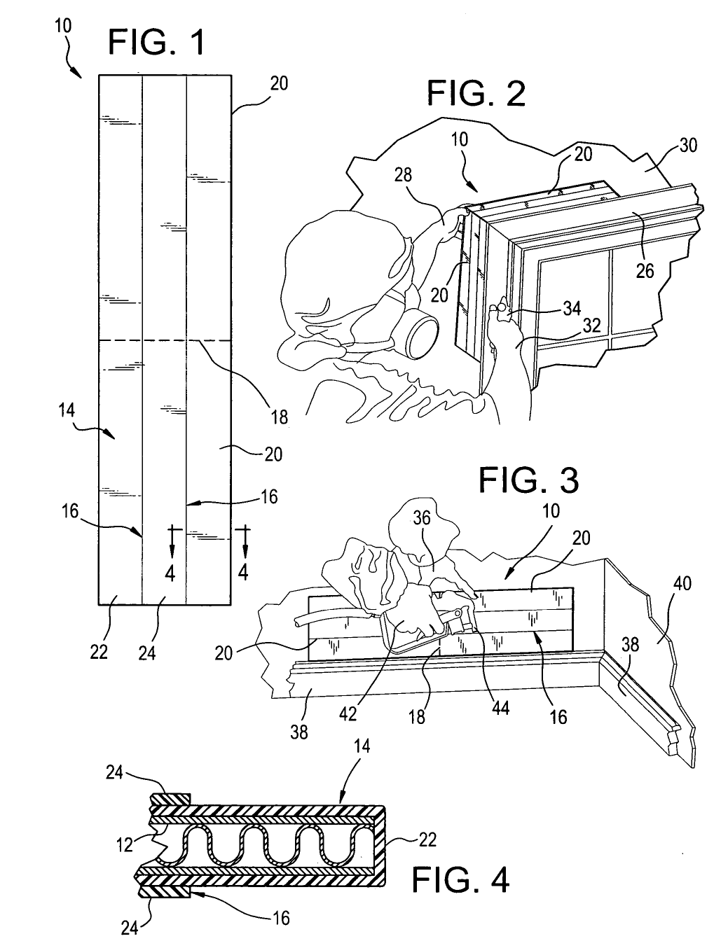

Similar reference characters denote corresponding features consistently throughout the accompanying drawings.

### DETAILED DESCRIPTION OF THE PREFERRED EMBODIMENT

Referring now to the FIGS., a paint shield in accordance with the present invention is shown at 10. Paint shield 10 includes an elongated strip of corrugated cardboard 12 encapsulated in a plastic coating 14 to prevent the absorption of liquids into cardboard strip 12. Plastic coating 14 is provided with ruled margins 16 running the length thereof to assist a user in gauging overspray amounts.

Cardboard strip 12 measures about 48 inches (122 cm) in length, 6 inches (15 cm) in height and 0.125 inches (3.18 mm) in width. Strip 12 is bisected by a fold line 18 into a pair of side-by-side panels 20 that can be folded back upon themselves to reduce the length of shield by one-half. Each panel 20 has a length of about 24 inches (61 cm) and a width of about 6 inches (15 cm). Of course, the dimensions of cardboard strip 12 are largely a matter of design choice and can be varied in accordance with user preferences.

Coating 14 includes a primary layer 22 that is positioned upon cardboard strip 12 and is adhesively fastened thereto. Primary layer 22 comprises a sheet of flexible and impermeable plastic covered on its inner surface with pressure-sensitive glue (not shown). The plastic sheet forming primary layer 22 is preferably one that latex and oil-based paints do not readily adhere to thereby permitting easy cleanup. During assembly of paint shield 10, primary layer 22 is tightly wrapped around cardboard strip 12, trimmed, and sealed at the ends thereof to provide a moisture-proof barrier jacketing cardboard strip 12.

Coating 14 also includes a secondary layer 24 positioned upon primary layer 22 and is adhesively fastened thereto. Secondary layer 24 comprises a strip of flexible, impermeable and moisture-repellant plastic covered on the inner surface thereof with pressure-sensitive glue (not shown). The plastic strip forming secondary layer 24 tightly encircles cardboard strip 12 covered by primary layer 22 midway between the top and bottom edges thereof. Secondary layer 24 reinforces primary layer 22, maintaining the sealed ends of primary layer 22 in a closed position and resisting fatigue damage at fold line 18.

Because secondary layer 24 is about 2 inches (5.1 cm) wide, a pair of margins 16 is provided between the top and bottom edges of secondary layer 24 and the top and bottom edges of paint shield 10 that are about 2 inches (5.1 cm) wide. If primary layer 22 and secondary layer 24 are formed of plastic having contrasting colors, margins 16 are readily visible and can be used by painters to judge the amount of overspray during painting operations. It should be appreciated that margins 16, can be provided to paint shield, for example, by printing ruled lines or bars along the length of paint shield 10 at predetermined distances from the top and bottom edges of paint shield 10.

The use of paint shield 10 is straightforward to paint a corner of a window frame 26 as illustrated in FIG. 2, shield 10 is folded along fold line 18 so that panels 20 are positioned at right angles to one another. Then, while grasping paint shield 10 in one hand 28 of the user, paint shield 10 is lowered onto window frame 26 such that the corner thereof touches fold line 18 and paint shield 10 is pressed snugly into the adjacent wall 30. Finally, with the other hand 32 of the user grasping a paint spray gun 34 the trigger thereof is squeezed to direct a flow of paint toward the designated corner of the window frame 26.

By examination of the amount of paint approaching and contacting margin 16 directly adjacent window frame 26, a user can judge the amount of overspray and can instantly correct the aim of spray gun 34 to minimize paint loss. (It is preferable that most of the oversprayed paint fall between one of margins 16 and the top or bottom edge of paint shield 10. Should significant amounts of paint land upon secondary layer 24, the aim of spray gun 34 should be adjusted or spray gun 34 should be moved closer to window frame 26.) Paint shield 10 automatically blocks paint from reaching wall 30 and collects overspray, splatters, drips, and minor spills throughout the process of painting window frame 26. When painting of window frame 26 is complete, paint shield 10 can be washed with soapy water or other cleaning liquid and immediately reused or it can be packed away for transport, storage and reuse at a later time.

To prevent overspray along straight lines as illustrated in FIG. 3, shield 10 is unfolded along fold line 18 so that panels 20 are positioned in a coplanar relationship. Next, while grasping shield 10 in one hand 36, the bottom of unfolded shield 10 is lowered onto the top of floor molding 38 and is pressed snugly into the adjacent wall 40. Afterward, with the other hand 42 grasping a paint spray gun 44 the trigger thereof is squeezed to direct a flow of paint toward molding 38. By examining of the amount of paint contacting margin 16 adjacent molding 38, a user can judge the amount of overspray and can correct the aim of spray gun 44 as described above. When painting is complete, paint shield 10 can be washed and packed away for subsequent reuse.

While paint shield 10 has been described with a high degree of particularity, it will be appreciated by those skilled in the art that modifications may be made to it. Therefore, it is to be understood that the present invention is not limited entirely to the sole paint shield embodiment described above, but encompasses any and all embodiments within the scope of the following claims.

I claim:

1. A paint shield, comprising:
an elongated strip of corrugated cardboard;
an impermeable plastic coating encapsulating said strip of corrugated cardboard; and,
said plastic coating being provided with ruled margins running the length thereof for gauging overspray amounts.

2. A paint shield, comprising:
an elongated strip of corrugated cardboard having top and bottom edges connected by a pair of opposed ends;
an impermeable plastic coating encapsulating said strip of corrugated cardboard, said plastic coating including:
a primary layer being positioned upon said cardboard strip and being adhesively fastened thereto; and,
a secondary layer being positioned upon said primary layer and being adhesively fastened thereto, said secondary layer encircling said strip of corrugated cardboard, from one of said opposed ends to the other, between the top and bottom edges thereof.

3. A paint shield, comprising:
an elongated strip of corrugated cardboard having a top edge and a bottom edge connected by a pair of opposed ends;
an impermeable plastic coating encapsulating said strip of corrugated cardboard, said plastic coating including:
a primary layer being positioned upon said cardboard strip and being adhesively fastened thereto; and,
a secondary layer encircling said strip of corrugated cardboard, from one of said opposed ends to the other, between the top and bottom edges thereof, and the top and bottom of said secondary layer defining ruled margins running the length of said strip of corrugated cardboard for gauging overspray amounts.
